(19) United States
(12) Patent Application Publication
(10) Pub. No.: US 2013/0081952 A1
(43) Pub. Date: Apr. 4, 2013

(54) METHOD FOR MANUFACTURING COLORED ALUMINUM PRODUCT OR COLORED ALUMINUM ALLOY PRODUCT, PIGMENT COMPOSITION FOR COLORATION, AND COLORED ALUMINUM PRODUCT OR COLORED ALUMINUM ALLOY PRODUCT

(71) Applicants: Yasuichi Akimoto, Tokyo (JP); Morihiro Noda, Nara-shi (JP); Takumi Mori, Minoh-shi (JP)

(72) Inventors: Yasuichi Akimoto, Tokyo (JP); Morihiro Noda, Nara-shi (JP); Takumi Mori, Minoh-shi (JP)

(73) Assignees: DENKAHIMAKUKOUGYOU CO., LTD., Tokyo (JP); D&C COMMERCIAL CO., LTD., Osaka (JP); KURETAKE CO., LTD., Nara-shi (JP)

(21) Appl. No.: 13/618,567

(22) Filed: Sep. 14, 2012

(30) Foreign Application Priority Data
Sep. 29, 2011 (JP) 2011-214413
Aug. 22, 2012 (JP) 2012-183547

(51) Int. Cl. C25D 11/04; C08L 33/00

(52) U.S. Cl. 205/50; 205/202; 524/556

(57) ABSTRACT

A method for manufacturing a colored aluminum product or a colored aluminum alloy product includes the following steps of (i) subjecting a substrate made of aluminum or aluminum alloy to an anodic oxidation in a treatment solution containing phosphoric acid to form an anodic oxidation film having a plurality of pores on a surface of the substrate, (ii) treating the substrate with warm water having a temperature between 40 and 100° C., and (iii) immersing the substrate in a pigment composition for coloration includes pigment particles, a dispersing agent and water to fill the pigment particles into a plurality of the pores in the anodic oxidation film on the surface of the substrate, thereby performing coloration.

### CROSS-REFERENCE TO RELATED APPLICATIONS

This application is based upon and claims the benefit of priority from prior Japanese Patent Applications No. 2011-214413, filed Sep. 29, 2011; and No. 2012-183547, filed Aug. 22, 2012, the entire contents of all of which are incorporated herein by reference.

### BACKGROUND OF THE INVENTION

1. Field of the Invention

The present invention relates to a method for manufacturing a colored aluminum product or a colored aluminum alloy product, a pigment composition for coloration, and a colored aluminum product or a colored aluminum alloy product.

2. Description of the Related Art

Aluminum products or aluminum alloy products, for example an exterior member of a cell phone are colored for protecting the surface or raising the aesthetical beauty thereof.

The following methods have hitherto been known, for coloration of a substrate made of aluminum or alloy thereof. First, a substrate made of aluminum or alloy thereof is subjected to an anodic oxidation treatment, for example, in a sulfuric acid solution to form a porous anodic oxidation film on the surface of the substrate. Subsequently, the substrate, which has been treated with the anodic oxidation, is immersed in a dye solution to impregnate the porous anodic oxidation film with the dye, thereby performing the coloration.

According to such a coloring method, however, because the dye is used as the coloring agent, the fastness property upon exposure to sunlight is low, and the dye is decomposed and volatilized by heat, thus resulting in decoloration.

Under the above circumstances, Jpn. Pat. Appln. Kokoku Publication No. 52-5010 describes a method for coloring a substrate made of aluminum or alloy thereof as shown below. An anodic oxidation is performed using a phosphoric acid solution instead of the sulfuric acid solution to form a porous anodic oxidation film having a relatively large pore size. Subsequently, this substrate is immersed in an aqueous pigment dispersion, in which pigment particles having a particle size of about 1 μm, preferably 0.5 μm or less are finely dispersed, to adsorb the pigment to the porous anodic oxidation film, thereby performing the coloration.

The following facts, however, have been revealed by the present inventors' replication study of the coloring method described above. It is found that the resulting colored aluminum product or colored aluminum alloy product represents a small color difference compared with a substrate made of aluminum or alloy thereof before coloration as a standard, and thus it is not sufficiently colored, it is also found that unevenness in color tone occurs. It can be considered that this results from the insufficient filling of the pigment particles in pores in the porous anodic oxidation film on the substrate.

On the other hand, Japanese Patent No. 3410540 discloses a pigment dispersion used for filling a pigment in pores with a diameter of 50 to 250 nm in an oxidation film on a substrate made of aluminum or alloy thereof by an electrophoresis method to color the substrate. In the pigment dispersion, pigment particles having a predetermined particle size distribution are dispersed.

### BRIEF SUMMARY OF THE INVENTION

It is an object of the present invention to provide a method for manufacturing a colored aluminum product or colored aluminum alloy product having a sufficiently large color difference compared with a substrate made of aluminum or alloy thereof before coloration as a standard, and having a high heat resistance in which chromaticity is not lowered even if it is heated, only in a simple step in which the substrate is immersed in a pigment composition for coloration without using an electrophoresis in the coloration step.

It is another object of the present invention, to provide a pigment composition for coloration which can be preferably utilized in the production method described above.

It is an object of the present invention to further provide an aluminum product or aluminum alloy product colored black, red, blue, yellow, green or white, which has a predetermined color difference compared with a substrate made of aluminum or alloy thereof before coloration as a standard, and which has a high heat resistance.

According to a first, aspect of the present invention, there is provided a method for manufacturing a colored aluminum product or a colored aluminum alloy product, comprising the following steps of: (i) subjecting a substrate made of aluminum or aluminum alloy to an anodic oxidation in a treatment solution containing phosphoric acid to form an anodic oxidation film having a plurality of pores on a surface of the substrate; (ii) treating the substrate with warm water having a temperature of 40 to 100° C.; and (iii) immersing the substrate in a pigment composition for coloration comprising pigment particles, a dispersing agent and water to fill the pigment particles into a plurality of the pores in the anodic oxidation film on the surface of the substrate, thereby performing coloration.

According to a second aspect of the present invention, there is provided a method for manufacturing a colored aluminum product or a colored aluminum alloy product comprising the following steps of: (i) subjecting a substrate made of aluminum or aluminum alloy to an anodic oxidation in a treatment solution containing phosphoric acid to form an anodic oxidation film having a plurality of pores on a surface of the substrate; (ii) washing the substrate with water and then drying it with hot air; and (iii) immersing the substrate in a pigment composition for coloration comprising pigment particles, a dispersing agent and water to fill the pigment particles into a plurality of the pores in the anodic oxidation film on the surface of the substrate, thereby performing coloration.

According to a third aspect of the present invention, there is provided a method for manufacturing a colored aluminum product or a colored aluminum alloy product, comprising the following steps of: (i) subjecting a substrate made of aluminum or aluminum alloy to an anodic oxidation in a treatment solution containing phosphoric acid to form an anodic oxidation film having a plurality of pores on a surface of the substrate; (ii) treating the substrate with an alkaline aqueous solution having a pH between 9.0 and 10.0, and then washing it with water; and (iii) immersing the substrate in a pigment composition for coloration comprising pigment particles, a dispersing agent and water to fill the pigment particles into a plurality of the pores in the anodic oxidation film on the surface of the substrate, thereby performing coloration.

According to a fourth aspect of the present invention, there is provided a pigment composition for coloration which is used in the methods for manufacturing the colored aluminum product or the colored aluminum alloy product according to the first to third aspects, comprising pigment particles, a dispersing agent and water, and having an oxidation-reduction potential of 200 mV or less, wherein the pigment particles have a particle size distribution in which a particle size of D 80 is less than a pore size of the minimum pore of a plurality of pores in an anodic oxidation film in a state in which the pigment particles are dispersed in the water containing the dispersing agent.

According to a fifth aspect of the present invention, there is provided a colored aluminum product or colored aluminum alloy product, comprising a substrate made of aluminum or aluminum alloy; an anodic oxidation film formed on a surface of the substrate and having a plurality of pores with a pore size between 20 and 200 nm and a depth between 1 and 50 μm in a thickness direction from the surface; and black pigment particles having a particle size less than the pore size of the pore and filling into a plurality of the pores in the anodic oxidation film so that a color difference, compared with the substrate before coloration as a standard, is 44 or more.

According to a sixth aspect of the present invention, there is provided a colored aluminum product or colored aluminum alloy product, comprising a substrate made of aluminum or aluminum alloy; an anodic oxidation film formed on a surface of the substrate and having a plurality of pores with a pore size between 20 and 200 nm and a depth between 1 and 50 μm in a thickness direction from the surface; and red pigment particles having a particle size less than the pore size of the pore and filling into a plurality of the pores in the anodic oxidation film so that a color difference, compared with the substrate before coloration as a standard, is 40 or more.

According to a seventh aspect of the present invention, there is provided a colored aluminum product or colored aluminum alloy product, comprising a substrate made of aluminum or aluminum alloy; an anodic oxidation film, formed on a surface of the substrate, having a plurality of pores with a pore size between 20 and 200 nm and a depth between 1 and 50 μm in a thickness direction from the surface; and blue pigment particles having a particle size less than the pore size of the pore and filling into a plurality of the pores in the anodic oxidation film so that a color difference, compared with the substrate before coloration as a standard, is 50 or more.

According to an eighth aspect of the present invention, there is provided a colored aluminum product or colored aluminum alloy product, comprising a substrate made of aluminum or aluminum alloy; an anodic oxidation film, formed on a surface of the substrate, having a plurality of pores with a pore size between 20 and 200 nm and a depth between 1 and 50 μm in a thickness direction from the surface; and yellow pigment particles having a particle size less than the pore size of the pore and filling into a plurality of the pores in the anodic oxidation film so that a color difference, compared with the substrate before coloration as a standard, is 30 or more.

According to a ninth aspect of the present invention, there is provided a colored aluminum product or colored aluminum alloy product, comprising a substrate made of aluminum or aluminum alloy; an anodic oxidation film formed on a surface of the substrate and having a plurality of pores with a pore size between 20 and 200 nm and a depth between 1 and 50 μm in a thickness direction from the surface; and green pigment particles having a particle size less than the pore size of the pore and filling into a plurality of the pores in the anodic oxidation film so that a color difference, compared with the substrate before coloration as a standard, is 45 or more.

According to a tenth aspect of the present invention, there is provided a colored aluminum product or colored aluminum alloy product, comprising a substrate made of aluminum or aluminum alloy; an anodic oxidation film formed on a surface of the substrate and having a plurality of pores with a pore size between 20 and 200 nm and a depth between 1 and 50 μm in a thickness direction from the surface; and white pigment particles having a particle size less than the pore size of the pore and filling into a plurality of the pores in the anodic oxidation film so that a color difference, compared with the substrate before coloration as a standard, is 3.5 or more.

### DETAILED DESCRIPTION OF THE INVENTION

Embodiments of the present invention will be explained in detail below.

### First Embodiment

The method for manufacturing a colored aluminum product or colored aluminum alloy product of a first embodiment comprises the following steps:

(i) subjecting a substrate made of aluminum or aluminum alloy to an anodic oxidation in a treatment solution containing phosphoric acid to form an anodic oxidation film having a plurality of pores on a surface of the substrate;

(ii) treating the substrate with warm water having a temperature of 40 to 100° C.; and

(iii) immersing the substrate in a pigment composition for coloration comprising pigment particles, a dispersing agent and water to fill the pigment particles into a plurality of the pores in the anodic oxidation film on the surface of the substrate, thereby performing coloration.

Examples of the aluminum used in the step (i) include high-pure aluminum having a purity of 99.99% or more and pure aluminum having a purity of about 99% such as A 1050 and A 1100.

Examples of the aluminum alloy used in the step (i) include Al—Mn alloy such as A 3003 and A 3004; Al—Mg alloy such as A 5005, A 5052 and A 5083; Al—Si alloy such as A 4043; Al—Cu alloy such as A 2017 and A 2024; Al—Zn alloy such as A 7072; and Al—Mg—Si alloy such as A 6061 and A 6063.

The substrate used in the step (i) has an arbitrary shape such as a plate-like shape, a hollow shape of which a part is open, a bottomed cylindrical shape, a block shape such as a cast product or die cast product.

It is preferable that the treatment solution containing phosphoric acid used in the step (i) is an aqueous solution containing phosphoric acid in an amount of 40 to 450 q/L. The treatment solution may be used at an ordinary temperature (20° C.) or may be heated to a temperature of higher than 20° C. and 40° C. or lower.

In the anodic oxidation in the step (i), the voltage is preferably adjusted to, for example, 60 to 150 V when a current is constantly maintained by a direct-current voltage. The oxidation time depends on the voltage value described above, and it is preferably from one to 100 minutes. The anodic oxidation under such conditions can form an anodic oxidation film having a plurality of pores with a pore size between 20 and 200 nm and a depth between 1 and 50 μm in a thickness direction from the surface of the substrate. Here, the depth almost corresponds to a thickness of the anodic oxidation film. The pore size of the pore is a diameter of a pore which is exposed on the surface of the anodic oxidation film. The thickness of the anodic oxidation film and the pore size of the pore described above can be measured from cross-sectional electron micrographs of the substrate including the anodic oxidation film and surface electron micrographs of the anodic oxidation film.

With respect to the pores formed in the anodic oxidation film by the anodic oxidation in the step (i), a pore density, i.e., the number of the pores per the area of 25 μm² in the surface of the anodic oxidation film is preferably between 1000 and 2200.

Here, “the number of the pores per the area of 25 μm² in the surface of the anodic oxidation film” is obtained by photographing the anodic oxidation film surface using an electron microscope, visually observing an area of 0.25 μm² in the electron microgram, counting the number of the pores, and multiplying the obtained value by 100.

When the number of the pores is adjusted to the range described above, it is possible to advantageously color the anodic oxidation film, while the strength of the anodic oxidation film is maintained. The number of the pores is more preferably between 1000 and 1600 pores/25 μm².

The washing treatment with warm water in the step ii) enables an advantageous coloration, i.e., smooth penetration of the pigment particles into a plurality of the pores in the anodic oxidation film on the substrate and filling of a sufficient amount of the pigment particles in the pores, in the immersion of the substrate in the pigment composition for coloration in the subsequent step (iii).

According to experiments and studies carried out by the present inventors, it has been found that when the substrate is only washed with water having an ordinary temperature after the anodic oxidation in the treatment solution containing phosphoric acid and subsequently the substrate washed with water is immersed in the pigment composition for coloration comprising pigment particles, a dispersing agent and water, the anodic oxidation film formed on the surface of the substrate is not sufficiently colored. It can be assumed that this occurs because phosphate ions remaining in a plurality of the pores in the anodic oxidation film cannot be removed by the washing treatment with water having an ordinary temperature, and these phosphate ions prevent the penetration of the pigment particles in the pigment composition for coloration into the pores.

For the above reason, the present inventors have performed the washing treatment with water of the substrate using warm water having a temperature of 40° C. to 100° C. instead of water having an ordinary temperature before the coloration step using the pigment composition for coloration. As a result, it has been surprisingly found that when the substrate washed with water is immersed in the pigment composition for coloration comprising the pigment particles, the dispersing agent and water, a color difference of the anodic oxidation film compared with the substrate before the coloration as a standard becomes sufficiently large, and advantageous coloration can be achieved. It can be assumed that this results from the following actions. The phosphoric acid ions remaining in a plurality of the pores by the anodic oxidation are removed by the washing treatment with warm water. After that, when the resulting substrate is immersed in the pigment composition for coloration, the pigment particles in the composition smoothly penetrate into a plurality of the pores, thus resulting in filling of a sufficient amount of pigment particles in the pores.

When the warm water has a temperature of lower than 40° C., it is difficult, to sufficiently color the anodic oxidation film, even if the substrate which has been washed with water is immersed in the pigment composition for coloration comprising the pigment particles, the dispersing agent and water. The temperature of the warm water is more preferably from 50° C. to 100° C., most preferably from 65° C. to 100° C.

Examples of the pigment particles in the pigment composition for coloration used in the step (iii) include black pigment particles, red pigment particles, green pigment particles, yellow pigment particles, blue pigment particles and white pigment particles. The pigment particles preferably have a particle size distribution in which particle sizes of D 80 or more are less than a pore size of the minimum pore of a plurality of the pores in the anodic oxidation film, and more preferably have a particle size distribution in which the pigment particle sizes of D 90 or more are less than a pore size of the minimum pore of a plurality of the pores in the anodic oxidation film.

Here, the “particle size” refers to a diameter when the pigment particles are in the shape of a sphere, and refers to the maximum length when the pigment particles are in the shape of a plane.

The terms “D80” and “D90” refer to the values obtained by the following method and calculation. Laser light is irradiated to a sample in which the pigment particles are dispersed in water containing the dispersing agent, the light scattered by the pigment particles is taken into a light-scattering particle size distribution measuring device (a dynamic light scattering LB-550 manufactured by Horiba, Ltd.), and an arithmetic processing is performed in the measuring device to obtain a particle size distribution of the pigment particles in the sample. From the resulting particle size distribution of the pigment particles, for example, a particle size distribution of 200 pigment particles, the pigment particles are arranged in increasing order of the particle size (from small to large), and the particle size of the pigment particle at the 160th from the smallest particle the 80th particle in a case of 100 particles) is specified as “D80” and the particle size of the pigment particle at the 180th from the smallest particle (the 90th particle in a case of 100 particles) is specified as “D90.”

The pigment particles having the particle size distribution in which the particle sizes of D 80 or more are less than the pore size of the minimum pore of a plurality of the pores (in the state in which the pigment particles are dispersed in water containing the dispersing agent) can smoothly penetrate all the way into a plurality of the pores in the anodic oxidation film (the side of the interface with the substrate), and can be filled therein, whereby the anodic oxidation film can be advantageously colored.

The particle sizes of D 80 or more which are less than a pore size of the minimum pore of a plurality of the pores are particle sizes corresponding to desirably 80% or less, preferably 70% or less, more preferably 60% or less, most preferably 50% or less, of the pore size of the minimum pore. The lower limit of the particle size of D 80 or more corresponds to preferably 30% of the pore size of the minimum pore.

Various dispersing agents may be used in the pigment composition for coloration used in the step (iii). Examples of the dispersing agent include an acrylic resin such as a styrene-acrylic resin or an acrylic acid resin, a styrene-maleic acid resin (all are anionic dispersing agents), polyvinyl alcohol or carboxymethyl cellulose. The styrene-acrylic resin preferably has a number average molecular weight of 5,000 to 50,000. The acrylic acid resin preferably has number average molecular weight of 10.000 to 50,000. The styrene-maleic acid resin preferably has a number average molecular weight of 1,000 to 30,000. The acrylic resins are particularly preferable, because they have a high penetration-promoting effect of the pigment particles into a plurality of the pores in the anodic oxidation film of the substrate. Of the acrylic resins, styrene-acrylic resins are more preferable.

The pigment composition for coloration used in the step (iii) preferably has an oxidation-reduction potential of 200 mV or less. When the pigment composition has an oxidation-reduction potential of more than 200 mV, it is difficult to sufficiently increase the penetration-promoting effect of the pigment particles into a plurality of the pores in the anodic oxidation film of the substrate. The oxidation-reduction potential is more preferably 150 mV or less, further more preferably 100 mV or less.

The pigment composition for coloration used in the step (iii) preferably has a pH of 6.5 to 11. The pigment composition may be used at an ordinary temperature, or may be heated to 30 to 75° C.

The pigment composition for coloration used in the step (iii) comprises the pigment particles, the dispersing agent and water, and the pigment particles preferably contain in a content of 3 to 30% by weight based on the total amount thereof, and the dispersing agent preferably contains as an active component in a content of 1 to 10% by weight based on the total amount thereof. In the pigment composition comprising the pigment particles and the dispersing agent in the amounts described above, an appropriate amount of the pigment particles results in a stable dispersion without aggregation. The pigment particles, therefore, can smoothly penetrate into a plurality of the pores in the anodic oxidation film, and a sufficient amount of the particles can be filled in the pores. As a result, it is possible to perform the coloration in which a color difference compared with the substrate before the coloration as a standard becomes sufficiently large.

The pigment composition for coloration used in the method for manufacturing the colored aluminum product or colored aluminum alloy product of the first embodiment preferably has following properties:

(a) the composition has the pigment particles, the dispersing agent and water;

(b) the pigment particles have a particle size distribution in which particle sizes of D 80 or more are less than the pore size of the minimum pore of a plurality of the pores in the anodic oxidation film in a state in which the pigment particles are dispersed in the water containing the dispersing agent;

(c) the composition has the oxidation-reduction potential of 200 mV or less; and

(d) the dispersing agent is the acrylic resin.

The more preferable pigment composition for coloration used in the method for manufacturing the colored aluminum product or colored aluminum alloy product of the first embodiment has following properties:

(a) the composition comprises the pigment particles, the dispersing agent and water;

(b) the pigment particles have a particle size distribution in which the particle sizes of D 80 or more (more preferably D 90 or more) are less than the bore size of the minimum pore of a plurality of the pores in the anodic oxidation film in a state in which the pigment particles are dispersed in the water containing the dispersing agent;

(c) the composition has the oxidation-reduction potential of 100 mV or less;

(d) the dispersing agent is a styrene-acrylic resin; and

(e) the pigment particles and the dispersing agent contain in a content of 9 to 21% by weight and 3 to 7% by weight based on the total amount of the pigment particles, the acrylic dispersing agent and water, respectively.

In the first embodiment, after the anodic oxidation film is colored by using the pigment composition for coloration, it is immersed in isopropyl alcohol or water, thereby permitting the aggregation of the pigment particles in the pores. Such a treatment enables bright colors and increased color depth.

According to the first embodiment as explained above, the method for manufacturing the colored aluminum product or colored aluminum alloy product having the sufficiently large color difference compared with the substrate made of aluminum or alloy thereof before the coloration as the standard and having the high heat resistance in which the chromaticity is not lowered even if it is heated can be provided which has a simple step in which after the washing with warm water having a temperature of 40 to 100° C., the immersion in the pigment composition for coloration is performed, without using an electrophoresis in the coloration step.

In addition, according to the first embodiment, the pigment composition for coloration can be provided which is preferably applicable to the method for manufacturing the colored aluminum product or colored aluminum alloy product described above.

### Second Embodiment

A method for manufacturing a colored aluminum product or colored aluminum alloy product of a second embodiment includes the following steps of:

(i) subjecting a substrate made of aluminum or aluminum alloy to an anodic oxidation in a treatment solution containing phosphoric acid to form an anodic oxidation film having a plurality of pores on a surface of the substrate;

(ii) washing the substrate with water and then drying it with hot air; and

(iii) immersing the substrate in a pigment composition for coloration comprising pigment particles, a dispersing agent and water to fill the pigment particles into a plurality of the pores in the anodic oxidation film on the surface of the substrate, thereby performing coloration.

The aluminum or alloy thereof used in the step (i) may include the same aluminum or alloy thereof as those explained in the first embodiment.

The detailed procedures of the step (i) are the same as in the first embodiment.

The drying with hot air after the washing treatment with water in the step (ii) enables an advantageous coloration, i.e., smooth penetration of the pigment particles into a plurality of the pores in the anodic oxidation film on the substrate and filling of a sufficient amount of the pigment particles in the pores, in the immersion of the substrate in the pigment composition for coloration in the subsequent step (iii).

According to experiments and studies carried out by the present inventors, it has been found that when the substrate is only washed with water having an ordinary temperature after the anodic oxidation in the treatment solution comprising phosphoric acid and subsequently the substrate is immersed in a pigment composition for coloration comprising pigment particles, a dispersing agent and water, the anodic oxidation film formed on the surface of the substrate is not sufficiently colored, it can be assumed that this occurs because phosphate ions remaining in a plurality of the pores in the anodic oxidation film cannot be removed by the washing treatment with water having an ordinary temperature, and these phosphate ions prevent the penetration of the pigment particles in the pigment composition for coloration into the cores.

For that reason, the present inventors have performed the washing treatment with water of the substrate at an ordinary temperature and then the drying thereof with hot air, before the coloration step using the pigment composition for coloration. As a result, it has been surprisingly found that when the dried substrate is immersed in the pigment composition for coloration comprising the pigment particles, the dispersing agent and water, a color difference of the anodic oxidation film compared with the substrate before the coloration as the standard becomes sufficiently large, and advantageous coloration can be achieved. It can be assumed that this results from the following actions. The phosphoric acid ions remaining in a plurality of the pores by the anodic oxidation are removed by drying them with hot air after the washing with water. After that, when the dried substrate is immersed in the pigment composition for coloration, the pigment particles in the composition smoothly penetrate into a plurality of the pores in the anodic oxidation film, thus resulting in filling of a sufficient amount of pigment particles in the pores.

For example, an immersing method or a spraying method is applicable to the washing with water in the step (ii).

The temperature of the hot air in the step (ii) is desirably between 50 and 150° C., more preferably between 70 and 100° C.

The detailed procedures of the step (iii) are the same as in the first embodiment.

The pigment composition for coloration used in the method for manufacturing the colored aluminum product or colored aluminum alloy product of the second embodiment preferably has following properties:

(a) the composition has the pigment particles, the dispersing agent and water;

(b) the pigment particles have a particle size distribution in which particle sizes of D 80 or more are less than the pore size of the minimum pore of a plurality of the pores in the anodic oxidation film in a state in which the pigment particles are dispersed in the water containing the dispersing agent;

(c) the composition has the oxidation-reduction potential of 200 mV or less; and

(d) the dispersing agent is the acrylic resin.

The more preferable pigment composition for coloration used in the method for manufacturing the colored aluminum product or colored aluminum alloy product of the second embodiment has following properties:

(a) the composition comprises the pigment particles, the dispersing agent and water;

(b) the pigment particles have a particle size distribution in which the particle sizes of D 80 or more (more preferably D 90 or more) are less than the pore size of the minimum pore of a plurality of the pores in the anodic oxidation film in a state in which the pigment particles are dispersed in the water containing the dispersing agent;

(c) the composition has the oxidation-reduction potential of 100 mV or less;

(d) the dispersing agent is a styrene-acrylic resin; and

(e) the pigment particles and the dispersing agent contain in a content of 9 to 21% by weight and 3 to 7% by weight based on the total amount of the pigment particles, the acrylic dispersing agent and water, respectively.

According to the second embodiment as explained above, the method for manufacturing the colored aluminum product or colored aluminum alloy product having a sufficiently large color difference compared with the substrate made of aluminum or alloy thereof before the coloration as a standard and having a high heat resistance in which the chromaticity is not lowered even if it is heated can be provided which has a simple step in which after the washing with water and then the drying with hot air, the immersion in the pigment composition for coloration is performed, without using an electrophoresis in the coloration step.

In addition, according to the second embodiment, the pigment composition for coloration can be provided which is preferably applicable to the method for manufacturing the colored aluminum product or colored aluminum alloy product described above.

### Third Embodiment

A method for manufacturing a colored aluminum product or a colored aluminum alloy product of a third embodiment includes the following steps of:

(i) subjecting a substrate made of aluminum or aluminum alloy to an anodic oxidation in a treatment solution containing phosphoric acid to form an anodic oxidation film having a plurality of pores on a surface of the substrate;

(ii) treating the substrate with an alkaline aqueous solution having a pH between 9.0 and 10.0, and then washing it with water; and

(iii) immersing the substrate in a pigment composition for coloration comprising pigment particles, a dispersing agent and water to fill the pigment particles into a plurality of the pores in the anodic oxidation film on the surface of the substrate, thereby performing coloration.

The aluminum or alloy thereof used in the step (i) may include the same aluminum or alloy thereof as those explained in the first embodiment.

The detailed procedures of the step (i) are the same as in the first embodiment.

The treatment of the substrate with the alkaline aqueous solution having a pH of 9.0 to 10.0, and then the washing with water in the step (ii) enable an advantageous coloration, i.e., smooth penetration of the pigment particles into a plurality of the pores in the anodic oxidation film on the substrate and filling of a sufficient amount of the pigment particles in the pores in the immersion of the substrate in the pigment composition for coloration in the subsequent step (iii).

According to experiments and studies carried out by the present inventors, it has been found that when the substrate is only washed with water after the anodic oxidation in the treatment solution containing phosphoric acid, and after that the substrate is immersed in a pigment composition for coloration comprising pigment particles, a dispersing agent and water, the anodic oxidation film formed on the surface of the substrate is not sufficiently colored. It can be assumed that this occurs because phosphate ions remaining in a plurality of the pores in the anodic oxidation film cannot be removed by only the washing treatment with water, and these phosphate ions prevent the penetration of the pigment particles in the pigment composition for coloration into the pores.

For that reason, the present inventors have performed the treatment of the substrate before the coloration step using the pigment composition for coloration with the alkaline aqueous solution having a pH of 9.0 to 10.0, and then the washing with water. As a result, it has been surprisingly found that when the substrate is immersed in the pigment composition for coloration comprising the pigment particles, the dispersing agent and water, a color difference of the anodic oxidation film compared with the substrate before the coloration as the standard becomes sufficiently large, and advantageous coloration can be achieved. It can be assumed that this results from the following actions. The treatment with the alkaline aqueous solution having a pH of 9.0 to 10.0 causes the phosphoric acid ions remaining in a plurality of the pores by the anodic oxidation to be neutralized by the alkaline and be removed. When the substrate is immersed in the pigment composition for coloration, the pigment particles in the composition smoothly penetrate into a plurality of the pores in the anodic oxidation film, thus resulting in filling of a sufficient amount of pigment particles in the pores.

Any alkaline aqueous solution may be used in the step (ii), so long as the solution in which an inorganic alkali agent or an organic alkali agent is dissolved in water has a pH of 9.0 to 10.0. Examples of the inorganic alkali agent include ammonium hydroxide, sodium hydroxide, and sodium carbonate. An aqueous ammonium hydroxide solution, sodium carbonate, and an aqueous tetramethyl ammonium hydroxide (TMAH) solution are particularly preferable as the alkaline aqueous solution. The alkaline aqueous solution having a temperature lower than an ordinary temperature (20° C.), the ordinary temperature, or higher than the ordinary temperature, obtained by heating the solution, can be used.

When the alkaline aqueous solution used in the step (ii) has a pH of less than 9.0, it becomes difficult to color the anodic oxidation film by the pigment particles so that the color difference compared with the substrate before the coloration as the standard is sufficiently large. On the other hand, when the alkaline aqueous solution has a pH of more than 10.0, the and oxidation film formed on the substrate surface may be dissolved. The alkaline aqueous solution has more preferably a pH of 9.5 to 10.0.

For example, an immersing method and a spraying method are applicable to the treatment with the alkaline aqueous solution in the step (ii). The time for the treatment with the alkaline aqueous solution is desirably from one second to 30 minutes, more preferably from 30 seconds to 5 minutes.

For example, an immersing method or a spraying method is applicable to the washing with water in the step (ii). The water used for washing may be used at an ordinary temperature or may be heated.

In the step (ii), it is preferable to dry the substrate after the washing with water. The drying is preferably performed by blowing air having an ordinary temperature to the substrate until the water in the anodic oxidation film disappears.

The detailed procedures of the step (iii) are the same as in the first embodiment.

The pigment composition for coloration used in the method for manufacturing the colored aluminum product or colored aluminum alloy product of the third embodiment preferably has following properties:

(a) the composition has the pigment particles, the dispersing agent and water;

(b) the pigment particles have a particle size distribution in which particle sizes of D 80 or more are less than the pore size of the minimum pore of a plurality of the pores in the anodic oxidation film in a state in which the pigment particles are dispersed in the water containing the dispersing agent;

(c) the composition has the oxidation-reduction potential of 200 mV or less; and

(d) the dispersing agent is the acrylic resin.

The more preferable pigment composition for coloration used in the method for manufacturing the colored aluminum product or colored aluminum alloy product of the third embodiment has following properties:

(a) the composition comprises the pigment particles, the dispersing agent and water;

(b) the pigment particles have a particle size distribution in which the particle sizes of D 80 or more (more preferably D 90 or more) are less than the pore size of the minimum pore of a plurality of the pores in the anodic oxidation film in a state in which the pigment particles are dispersed in the water containing the dispersing agent;

(c) the composition has the oxidation-reduction potential of 100 mV or less;

(d) the dispersing agent is a styrene-acrylic resin; and

(e) the pigment particles and the dispersing agent contain in a content of 9 to 21% by weight and 3 to 7% by weight based on the total amount of the pigment particles, the acrylic dispersing agent and water, respectively.

According to the third embodiment as explained above, the method for manufacturing the colored aluminum product or colored aluminum alloy product having a sufficiently large color difference compared with the substrate made of aluminum or alloy thereof before the coloration as the standard and having a high heat resistance in which the chromaticity is not lowered even if it is heated can be provided which has a simple step in which after the treatment of the substrate with the alkaline aqueous solution having a pH of 9.0 to 10.0 and then the washing with water, the immersion in the pigment composition for coloration is performed, without using an electrophoresis in the coloration step.

In addition, according to the third embodiment, the pigment composition for coloration which is preferably applicable to the method for manufacturing the colored aluminum product or colored aluminum alloy product described above can be provided.

### Fourth Embodiment

A colored aluminum product or colored aluminum alloy product of a fourth embodiment includes: a substrate made of aluminum or aluminum alloy; an anodic oxidation film formed on a surface of the substrate and having a plurality of pores with a pore size between 20 and 200 nm and a depth between 1 and 50 μm in a thickness direction from the surface; and pigment particles filled in a plurality of the pores in the anodic oxidation film and having a particle size less than a pore size of the pore. The degree of filling of the pigment particles in the pores is specified using, as an indicator, a color difference compared with the substrate before coloration as a standard. The color difference specified varies depending on the color of the pigment particles, as shown below.

Black pigment particles; a color difference (ΔE), compared with the substrate before the coloration as a standard, of 44 or more

Red pigment particles: a color difference (ΔE), compared with the substrate before the coloration as a standard, of 40 or more

Blue pigment particles; a color difference (ΔE), compared with the substrate before the coloration as a standard, of 50 or more

Yellow pigment particles: a color difference (ΔE), compared with the substrate before the coloration as a standard, of 30 or more

Green pigment particles: a color difference (ΔE), compared with the substrate before the coloration as a standard, of 45 or more

White pigment particles: a color difference (ΔE), compared with the substrate before the coloration as a standard, of 3.5 or more

Examples of the aluminum used as the substrate include high-pure aluminum having a purity of 99.99% or more and pure aluminum having a purity of about 99% such as A 1050 and A 1100. Examples of the aluminum alloy used as the substrate include Al—Mn alloy such as A 3003 and A 3004; Al—Mg alloy such as A 5005, A 5052 and A 5083; Al—Si alloy such as A 4043; Al—Cu alloy such as A 2017 and A 2024; Al—Zn alloy such as A 7072; and Al—Mg—Si alloy such as A 6061 and A 6063.

The substrate has an arbitrary shape such as a plate-like shape, a hollow shape of which a part is open, a bottomed cylindrical shape and a block shape such as a cast product or die cast product.

When a plurality of the pores formed in the anodic oxidation film have a pore size of less than 20 nm, the particle sizes of the pigment particles capable of filling in the pores become minute, the filling of the pigment particles into the pores is reduced, and it is difficult for the color difference (ΔE), which is the indicator of coloration, to reach the desired value or more. On the other hand, when the pores exceed a pore size of 200 nm, a partition all between the pores in the anodic oxidation film becomes thin, thus the strength of the anodic oxidation film may be reduced. The pore size of the pore is more preferably between 70 and 170 nm.

When the depth of the pore is less than 1 μm in a thickness direction from the surface, an absolute amount of the pigment particles filled in the pores is lowered, and it is difficult for the color difference (ΔE), which is the indicator for coloration, to reach the desired value. On the other hand, when the depth of the pore is more than 50 μm in a thickness direction from the surface, the strength of the anodic oxidation film may possibly be reduced. The depth of the pore is more preferably between 2 and 20 μm in a thickness direction from the surface.

The pore density of the anodic oxidation film, i.e., the number of the pores per the area of 25 pmt in the surface of the anodic oxidation film is preferably between 1000 and 2200.

Here, “the number of the pores per the area of 25 μm² in the surface of the anodic oxidation film” is obtained by photographing the anodic oxidation film surface using an electron microscope, visually observing a surface area of 0.25 μm² in the electron microgram, counting the number of the pores, and multiplying the obtained value by 100.

When the number of the pores is adjusted to the range described above, it is possible to obtain the colored aluminum product or colored aluminum alloy product in which the anodic oxidation film is advantageously colored while the strength of the anodic oxidation film is maintained. The number of pores is more preferably between 1000 and 1600 pores/25 μm².

The pigment particle has a particle size of 80% or less, preferably 70% or less, more preferably 60% or less, most preferably 50% or less, of the pore size of the pores in the anodic oxidation film. Here, the “particle size” refers to a diameter when the pigment particles are in the shape of a sphere, and refers to the maximum length when the pigment particles are in the shape of a plane. The pigment particles having such a particle size penetrate all the way into the pore in the anodic oxidation film and are densely filled in the pore. It is possible, therefore, to obtain the colored aluminum product or colored aluminum alloy product having a desired value or more of the color difference which is the indicator of coloration. The lower limit of the particle size of the pigment particle preferably corresponds to 30% of the pore size of the pore.

A dispersing agent (preferably an acrylic resin such as a styrene-acrylic acid (SA) copolymer) is filled, together with the pigment particles in the pores in the anodic oxidation film.

As explained above, according to the fourth embodiment, the black, red, blue, yellow, green or white-colored aluminum product or colored aluminum alloy product can be provided which has a predetermined value of color difference compared with the substrate made of aluminum or alloy thereof before the coloration as the standard, and has a high heat resistance.

Examples of the present invention will be explained in detail below.

In Examples and Comparative Examples described below, “D 50” and “D 80” of a pigment particle were specified by the following method and calculation. Laser light is irradiated to a sample in which pigment particles are dispersed in water containing a dispersing agent, and the light scattered by the pigment particles enters a light-scattering particle size distribution measuring device (a dynamic light-scattering LB-550 manufactured by Horiba, Ltd.). After that, an arithmetic processing is performed in the measuring device to obtain a particle size distribution of the pigment particles in the sample. From the resulting particle size distribution of the pigment particles, for example, a particle size distribution of 200 pigment particles, the pigment particles are arranged in increasing order of the particle size (from small to large). The particle size of the pigment particle at the 100th from the smallest particle (the 50th particle in a case of 100 particles) was specified as “D50,” and the particle size of the pigment particle at the 160th from the smallest particle (the 80th particle in a case of 100 particles) was specified as “D80.”

### Example 1

An Al substrate (pure aluminum: A 1050) having a width of 25 mm, a length of 50 mm and a thickness of 1 mm was prepared. After a surface of the Al substrate was degreased, it was subjected to an anodic oxidation under the following conditions.

### <Anodic Oxidation Conditions>

Treatment Solution: an aqueous solution containing 150 g/L of phosphoric acid (at an ordinary temperature)
Voltage and Current upon Electrolysis: 90 V and 1 A
Electrolysis Time: 50 minutes

An anodic oxidation film formed on the surface of the Al substrate has a thickness of 9.3 μm, and has a plurality of pores formed therein from the surface to an interface between the substrate and the anodic oxidation film. The minimum pore of the pores exposed on the surface had a pore size (the minimum pore size) of 170 nm. This depth of the pore corresponds to the thickness of the film. The thickness of the anodic oxidation film and the pore size of the pore were confirmed by cross-sectional electron micrographs of the substrate including the anodic oxidation film, and surface electron micrographs of the anodic oxidation

In addition, the number of pores per the area of 25 μm² in the surface of the anodic oxidation film was counted in the same manner as in the first embodiment described above. As a result, the number pores were 1170 pores/25 μm².

Subsequently, the Al substrate on which the anodic oxidation film was formed was immersed in warm water having a temperature of 70° C. for 30 minutes, and it was washed with water. After that, it was immersed in a pigment composition for coloration (liquid temperature: 20° C.) having the following composition for 30 minutes without drying it, thereby coloring the anodic oxidation film on the Al substrate black.

### <Pigment Composition for Coloration>

Black Pigment Particles: carbon black (having a particle size distribution in which a particle size of D 50 and a particle size of C 80 are 45.3 nm and 60.2 nm, respectively) 30 parts by weight
Dispersing Agent: styrene-acrylic resin (Hiross 2008 L (registered trademark) having a number average molecular weight of 20,000 manufactured by Seiko PMC Corporation) 33 parts by weight
Water: 100 parts by weight
Oxidation-Reduction Potential (ORP): −9 mV
pH: 8.56

### Example 2

An anodic oxidation film on an Al substrate was colored black in the same manner as in Example 1 except that a pigment composition for coloration having the following composition was used.

### <Pigment Composition for Coloration>

Black Pigment Particles: carbon black (having a particle size distribution in which a particle size of D 50 and a particle size of D 80 are 90.8 nm and 110 nm, respectively) 30 parts by weight.
Dispersing Agent: acrylic acid resin (Julimar AT-510 (registered trademark) having a number average molecular weight of about 25,000, manufactured by Toagosei Co., Ltd.) 33 parts by weight.
Water: 100 parts by weight
Oxidation-Reduction Potential (ORP): 167 mV
pH: 7.41

### Example 3

An anodic oxidation film on an Al substrate was colored black in the same manner as in Example 1 except that a pigment composition for coloration having the following composition was used,

### <Pigment Composition for Coloration>

Black Pigment Particles: carbon black (having a particle size distribution in which a particle size of D 50 and a particle size of D 80 are 77.2 nm and 98.9 nm, respectively) 30 parts by weight
Dispersing Agent: styrene-maleic acid resin (SMA-1440 H (registered trademark) having a number average molecular weight of 7,000 manufactured by SARTOMER Company) 30 parts by weight
Water: 100 parts by weight
Oxidation-Reduction Potential (ORP): 37 mV
pH: 7.97

### Example 4

An Al substrate on which an anodic oxidation film was formed by the same manner as in Example 1 was washed with water having an ordinary temperature (20° C.) for 30 minutes. Then, it was dried by blowing hot air having a temperature of 100° C. for 10 minutes. After that, the anodic oxidation film on the Al substrate was colored black by immersing it in the same pigment composition for coloration (liquid temperature: 20° C.) as in Example 1 for 60 minutes.

### Example 5

An Al substrate on which an anodic oxidation film was formed by the same manner as in Example 1 was immersed in an aqueous ammonium hydroxide solution having a pH of 9.5 for one minute, and it was washed with water having an ordinary temperature (20° C.) for 5 seconds. Then, the anodic oxidation film was dried by blowing air having an ordinary temperature until the moisture in the anodic oxidation film disappeared. The aqueous ammonium hydroxide solution was prepared by adding one drop (about 0.05 mL) of aqueous ammonia having a concentration of 38% to 50 mL of water. After that, the anodic oxidation film on the Al substrate was colored black by immersing it in the same pigment composition for coloration (liquid temperature: 20° C.) as in Example 1 for 60 minutes.

### Comparative Example 1

An anodic oxidation film was formed on an Al substrate in the same manner as in Example 1. Subsequently, the Al substrate was immersed in water having an ordinary temperature (20° C.) for 30 minutes to wash it with water. After that, it was immersed in a pigment composition for coloration (liquid temperature: 20° C.) having the following composition for 30 minutes without drying it, thereby coloring the anodic oxidation film on the Al substrate black.

### <Pigment Composition for Coloration>

Black Pigment Particles: carbon black (having a particle size distribution in which a particle size of D 80 is 115 nm) 30 parts by weight
Dispersing Agent: lauryl alcohol sulfate ammonium salt (Monogen Y-100 (registered trademark) manufactured by Dai-Ichi Kogyo Seiyaku Co,. Ltd.) 7.5 parts by weight
Water: 100 parts by weight
Oxidation-Reduction Potential (ORP): 300 my
pH: 4.34

### Comparative Example 2

After the surface of the same Al substrate (pure aluminum: A 1050) as in Example 1 was degreased, it was subjected to an anodic oxidation under the following conditions.

### <Anodic Oxidation Conditions>

Treatment Solution: an aqueous solution containing 180 g/L of sulfuric acid (at an ordinary temperature)
Voltage and Current Density upon Electrolysis: 16 V and 1 A/cm²
Electrolysis Time: 60 minutes

An anodic oxidation film formed on the surface of the Al substrate had a thickness of 5 μm, and had a plurality of pores formed therein from the surface to an interface between the substrate and the anodic oxidation film. The pores exposed on the surface had a pore size (the minimum pore size) of 50 nm. The thickness of the anodic oxidation film and the pore size of the pore were confirmed by cross-sectional electron micrographs of the substrate including the anodic oxidation film, and surface electron micrographs of the anodic oxidation film.

Then, the Al substrate, on which the anodic oxidation film was formed, was immersed in water having an ordinary temperature (20° C.) for 30 minutes to wash it with water. After that, it was immersed in a dye composition (liquid temperature: 20° C.) having the following composition for 30 minutes without drying it, thereby coloring the anodic oxidation film on the Al substrate black.

### <Dye Composition>

Black Dye: chromium premetalized dye (Black 421 (registered trademark) manufactured by Okuno Chemical Industries Co., Ltd.) 0.7 parts by weight
Water: 100 parts by weight
pH: 5.5

Degrees of coloration of the anodic oxidation films obtained from Examples 1 to 5 and Comparative Examples 1 and 2 were obtained from the color difference (ΔE) compared with the Al substrate before the anodic oxidation as a standard. The color differences were measured using a CM-2600 d manufactured by Minolta Co., Ltd.

In addition, the Al substrates in Examples 1 to 5 and Comparative Examples 1 and 2 were subjected to a heat-resistance test in which the substrate was exposed under an atmosphere of a temperature of 250° C. for 6 hours, and then color differences (ΔE) compared with that of the Al substrate before the anodic oxidation as the standard were measured.

These results are shown in Table 1 below.

TABLE 1

| | | | | | | | Color | ΔE after heat- |
|---|---|---|---|---|---|---|---|---|
| | | | | | | | difference (ΔE) | resistance test |
| | | Pigment composition for coloration | | | | | (standard: | (standard: |
| | Treatment after | | Pigment | | ORP | | anodic oxidation | anodic oxidation |
| | anodic oxidation | Color | particle | Dispersing agent | (mV) | pH | film uncolored) | film uncolored) |
| Example 1 | Washing with | Black | Carbon | Styrene-acrylic | −9 | 8.59 | 63.2 | 62.8 |
| | warm water | | black | resin | | | | |
| Example 2 | Washing with | Black | Carbon | Acrylic resin | 61 | 9.95 | 58.4 | 58.0 |
| | warm water | | black | | | | | |
| Example 3 | Washing with | Black | Carbon | Styrene-maleic | 37 | 7.97 | 23.8 | 23.4 |
| | warm water | | black | acid resin | | | | |
| Example 4 | Drying with hot | Black | Carbon | Styrene-acrylic | −9 | 8.59 | 53.7 | 53.3 |
| | air after washing | | black | resin | | | | |
| | with water | | | | | | | |
| Example 5 | Washing with | Black | Carbon | Styrene-acrylic | −9 | 8.59 | 62.4 | 58.6 |
| | water after | | black | resin | | | | |
| | treatment with | | | | | | | |
| | alkaline aqueous | | | | | | | |
| | solution | | | | | | | |
| Comparative | Washing with | Black | Carbon | Lauryl alcohol | 300 | 4.34 | 27.1 | 26.6 |
| Example 1 | water | | black | sulfate ammonium salt | | | | |

| | | | |
|---|---|---|---|
| Comparative | Note 1 | 43.3 | 0.8 |
| Example 2 | | | |

Note 1
using the black dye

As is apparent from Table 1 above, it can be seen that the anodic oxidation films were colored black with a color difference (ΔE) of 50 or more, in Examples 1 to 3 wherein the washing with warm water was performed after the anodic oxidation, Example 4 wherein the drying with hot air was performed after the anodic oxidation and then the washing with water, and Example 5 wherein the immersion in the aqueous ammonium hydroxide solution having a pH of 9.5 and then the washing with water was performed after the anodic oxidation. Conversely, the color difference (ΔE) was 27, and thus the film was hardly colored black in Comparative Example 1 wherein the washing with water having an ordinary temperature was performed after the anodic oxidation. It can be seen that, of Examples 1 to 3, the ΔE obtained in Example 1 using the styrene acrylic resin as the dispersing agent in the pigment composition for coloration was higher than those in Examples 2 and 3, and therefore it was colored denser black.

On the other hand, the color differences (ΔE) after the heat-resistance test of the anodic oxidation films in Examples 1 to 5 using the pigment particles for coloration were rarely different from that obtained before the test. In contrast to this, the color difference (ΔE) of Comparative Example 2 using the dye for the coloration was remarkably reduced by deodorizing at the heat-resistance test.

### Example 6

After the surface of the same Al substrate as in Example 1 was degreased, it was subjected to an anodic oxidation under the following conditions.

### <Anodic Oxidation Conditions>

Treatment Solution: an aqueous solution containing 150 g/L of phosphoric acid (at an ordinary temperature)
Voltage and Current upon Electrolysis: 45 V and 0.5 A
Electrolysis Time: 35 minutes

An anodic oxidation film formed on the surface of the Al substrate had a thickness of 3.3 μm, and had a plurality of pores formed therein from the surface to an interface between the substrate and the anodic oxidation film. The pores exposed on the surface had a pore size (the minimum pore size) of 66 nm. The depth of the pore corresponds to the film thickness. The thickness of the anodic oxidation film and the pore size of the pore were confirmed by cross-sectional electron micrographs of the substrate including the anodic oxidation film, and surface electron micrographs of the anodic oxidation film.

In addition, the number of pores per the area of 25 μm² in the surface of the anodic oxidation film was counted in the same manner as in the first embodiment described above. As a result, the number was 2170 pores/25 μm².

Subsequently, the Al substrate with the anodic oxidation film was immersed in warm water having a temperature of 70° C. for 30 minutes, and then it was washed with water. After that, it was immersed in the same pigment composition for coloration as in Example 1 for 30 minutes without drying it, thereby coloring the anodic oxidation film on the Al substrate black.

### Example 7

After the surface of the same Al substrate as in Example 1 was degreased, it was subjected to an anodic oxidation under the following conditions.

### <Anodic Oxidation Conditions>

Treatment Solution: an aqueous solution containing 150 g/L of phosphoric acid (at an ordinary temperature)
Voltage and Current upon Electrolysis: 65 V and 0.5 A
Electrolysis Time: 35 minutes

An anodic oxidation film formed on the surface of the Al substrate had a thickness of 4 μm, and had a plurality of pores formed therein from the surface to an interface between the substrate and the anodic oxidation film. The pores exposed on the surface had a pore size (the minimum pore size) of 125 nm. The depth of the pore corresponds to the film thickness. The thickness of the anodic oxidation film and the pore size of the pore were confirmed by cross-sectional electron micrographs of the substrate including the anodic oxidation film, and surface electron micrographs of the anodic oxidation film.

In addition, the number of pores per the area of 25 μm² in the surface of the anodic oxidation film was counted in the same manner as in the first embodiment described above. As a result, the number was 1530 pores/25 μm².

After that, the anodic oxidation film was colored black in the same manner as in Example 6.

### Example 8

After the surface of the same Al substrate as in Example 1 was degreased, it was subjected to an anodic oxidation under the following conditions.

### <Anodic Oxidation Conditions>

Treatment Solution: an aqueous solution containing 150 g/L of phosphoric acid (at an ordinary temperature)
Voltage and Current upon Electrolysis: 90 V and 1 A
Electrolysis Time: 35 minutes

An anodic oxidation film formed on the surface of the Al substrate had a thickness of 5.8 μm, and had a plurality of pores formed therein from the surface to an interface between the substrate and the anodic oxidation film. The pores exposed on the surface had a pore size (the minimum pore size) of 130 nm. The depth of the pore corresponds to the film thickness. The thickness of the anodic oxidation film and the pore size of the pore were confirmed by cross-sectional electron micrographs of the substrate including the anodic oxidation film, and surface electron micrographs of the anodic oxidation film.

In addition, the number of pores per the area of 25 μm² in the surface of the anodic oxidation film was counted in the same manner as in the first embodiment described above. As a result, the number was 1500 pores/25 μm².

After that, the anodic oxidation film was colored black in the same manner as in Example 6.

Color differences (ΔE) of the anodic oxidation films obtained from Examples 6 to 8 were measured in the same manner as in Example 1. The results are shown in Table 2 below.

TABLE 2

Anodic oxidation film

| | Thickness | Opening size | Color difference |
|---|---|---|---|
| | (μm) | of pore (nm) | (ΔE) |
| Example 6 | 3.3 | 66 | 44.1 |
| Example 7 | 4 | 125 | 54.7 |
| Example 8 | 5.8 | 130 | 61.8 |

As is apparent from Table 2 above, it can be seen that in Examples 6 to 8 wherein the anodic oxidation films having a plurality of the pores with the pore size of 50 to 200 nm and the depth of 3 to 10 μm in the thickness direction from the surface were washed with water and dried with hot air, the color differences (ΔE) of the anodic oxidation films were 44 or more, and thus they were colored deep black.

In Examples 6 to 8, the color differences (ΔE) after the heat-resistance test of the anodic oxidation films were rarely different from that before the test, as in Examples 1 to 5, though Table 2 does not show the data.

### Example 9

An anodic oxidation film on an Al substrate was colored red in the same manner as in Example 1 except that a pigment composition for coloration having the following composition was used.

### <Pigment Composition for Coloration>

Red Pigment Particles Pigment Red 112 (Naphthol Red) (having a particle size distribution in which a particle size of D 80 is 150 nm) 34 parts by weight
Dispersing Agent: styrene-acrylic resin (a trademark: Hiross 2008 L having a number average molecular weight of 20,000 manufactured by Seiko PMC Corporation) 38 parts by weight
Water: 100 parts by weight
Oxidation-Reduction Potential (ORP): 63 mV
pH: 8.8

### Example 10

An anodic oxidation film on an Al substrate was colored blue in the same manner as in Example 1 except that a pigment composition for coloration having the following composition was used.

### <Pigment Composition for Coloration>

Blue Pigment Particles: Pigment Blue 15 (Cyanine Blue HS-3) (having a particle size distribution in which a particle size of D 80 is 150 nm) 34 parts by weight
Dispersing Agent: styrene-acrylic resin (Hiross 2008 L (registered trademark) having a number average molecular weight of 20,000 manufactured by Seiko PMC Corporation) 38 parts by weight
Water: 100 parts by weight.
Oxidation-Reduction Potential (ORP): 27 mV
pH: 9.56

### Example 11

An anodic oxidation film on an Al substrate was colored yellow in the same manner as in Example 1 except that a pigment composition for coloration having the following composition was used.

### <Pigment Composition for Coloration:

Yellow Pigment Particles: Pigment Yellow 83 (Diazo Yellow) (having a particle size distribution in which a particle size of D 80 is 150 nm) 34 parts by weight
Dispersing Agent: styrene-acrylic resin (Hiross 2008 L (registered trademark) having a number average molecular weight of 5,000 manufactured by Seiko PMC Corporation) 38 parts by weight.
Water: 100 parts by weight
Oxidation-Reduction Potential (ORP): 12 my
pH: 9.66

### Example 12

An anodic oxidation film on an Al substrate was colored green in the same manner as in Example 1 except that a pigment composition for coloration having the following composition was used.

### <Pigment Composition for Coloration>

Green Pigment Particles: Pigment Green 7 (Cyanine Green 2 GE) (having a particle size distribution in which a particle size of D 80 is 150 nm) 34 parts by weight
Dispersing Agent: styrene-acrylic resin (Hiross 2008 L (registered trademark) having a number average molecular weight of 5,000 manufactured by Seiko PMC Corporation) 38 parts by weight
Water: 100 parts by weight
Oxidation-Reduction Potential (ORP): 57 mV
pH: 9.03

### Example 13

An anodic oxidation film on an Al substrate was colored white in the same manner as in Example 1 except that a pigment composition for coloration having the following composition was used.

### <Pigment Composition for Coloration>

White Pigment Particles: titanium oxide (having a particle size distribution in which a particle size of D 80 is 120 nm) 75 parts by weight
Dispersing Agent: styrene-acrylic resin (Hiross 2008 L (registered trademark) having a number average molecular weight of 5,000 manufactured by Seiko PMC Corporation) 10 parts by weight
Water: 100 parts by weight
Oxidation-Reduction Potential (ORP): 37 my
pH: 8.88

### Comparative Example 3

An anodic oxidation film was formed on an Al substrate in the same manner as in Example 1. Then, the Al substrate on which the anodic oxidation film was formed was immersed in water having an ordinary temperature (20° C.) for 30 minutes, and it was washed with water. After that, it was immersed in a pigment composition for coloration (liquid temperature: 20° C.) having the following composition for 30 minutes without drying it, thereby coloring the anodic oxidation film on the Al substrate red.

### <Pigment Composition for Coloration>

Red Pigment Particles: perylene red (having a particle size distribution in which a particle size of D 80 is 1970 nm) 20 parts by weight
Dispersing Agent: polyoxyethylenestearylamine (Nymeen 5220 (registered trademark) manufactured by NOF Corporation) 80 parts by weight
Water: 150 parts by weight
Oxidation-Reduction Potential (ORP): 130 mV
pH: 8.02

Color differences (ΔE) of the anodic oxidation films obtained from Examples 9 to 13 and Comparative Example 3, and color differences (ΔE) of the anodic oxidation films after a heat-resistance test were measured in the same manner as in Example 1. The results are shown in Table 3 below.

TABLE 3

| | | | | | | | Color | ΔE after heat- |
|---|---|---|---|---|---|---|---|---|
| | | | | | | | difference (ΔE) | resistance test |
| | Treatment | Pigment composition for coloration | | | | | (standard: | (standard: |
| | after anodic | | Pigment | | ORP | | anodic oxidation | anodic oxidation |
| | oxidation | Color | particle | Dispersing agent | (mV) | pH | film uncolored) | film uncolored) |
| Example 9 | Washing with | Red | Pigment | Styrene-acrylic | 57 | 8.21 | 57.1 | 36.5 |
| | warm water | | Red 112 | resin | | | | |
| Example 10 | Washing with | Blue | Pigment | Styrene-acrylic | 69 | 9.48 | 69.1 | 65.34 |
| | warm water | | Blue 15 | resin | | | | |
| Example 11 | Washing with | Yellow | Pigment | Styrene-acrylic | 46 | 9.30 | 45.8 | 43.04 |
| | warm water | | Yellow 83 | resin | | | | |
| Example 12 | Washing with | Green | Pigment | Styrene-acrylic | 65 | 8.59 | 65.5 | 64.99 |
| | warm water | | Green 7 | resin | | | | |
| Example 13 | Washing with | White | Titanium | Styrene-acrylic | 123 | 6.57 | 4.95 | 3.26 |
| | warm water | | oxide | resin | | | | |
| Comparative | Washing with | Red | Perylene | Polyoxyethylenestearylamine | 130 | 8.02 | 1.44 | Unmeasurable |
| Example 3 | water | | red | | | | | |

As is apparent from Table 3 above, it can be seen that in Examples 9 to 12 wherein the washing with warm water was performed after the anodic oxidation, the color differences (ΔE) of the anodic oxidation films were 40 or more, and thus they were colored deep colors. In Example 13 wherein the white pigment particles were used, the color difference (ΔE) of the anodic oxidation film became slightly low.

On the other hand, in Comparative Example 3 wherein the washing with water at an ordinary temperature after the anodic oxidation and then the red pigment particles were used, the color difference (ΔE) was 1.44 and thus the anodic oxidation film was hardly colored red, compared with that in Example 8 (using the red pigment particles).

On the other hand, the color differences (ΔE) after the heat-resistance test of the anodic oxidation films in Examples 9 to 13 using the pigment particles for coloration were rarely different from that obtained before the test. In Comparative Example 3, the color difference (ΔE) of the anodic oxidation film was too small to measure the color difference (ΔE) in the heat-resistance test.

What is claimed is:

1. A method for manufacturing a colored aluminum product or a colored aluminum alloy product, comprising the following steps of:
(i) subjecting a substrate made of aluminum or aluminum alloy to an anodic oxidation in a treatment solution containing phosphoric acid to form an anodic oxidation film having a plurality of pores on a surface of the substrate;
(ii) treating the substrate with warm water having a temperature of 40 to 100° C.; and
(iii) immersing the substrate in a pigment composition for coloration comprising pigment particles, a dispersing agent and water to fill the pigment particles into a plurality of the pores in the anodic oxidation film on the surface of the substrate, thereby performing coloration.

2. The method of claim 1, wherein the pore in the anodic oxidation film has a pore size between 20 and 200 nm and a depth between 1 and 50 μm in a thickness direction from the surface.

3. The method of claim 1, wherein the substrate is further dried with hot air after it is treated with the warm water in the step (ii).

4. A method for manufacturing a colored aluminum product or a colored aluminum alloy product, comprising the following steps of:
(i) subjecting a substrate made of aluminum or aluminum alloy to an anodic oxidation in a treatment solution containing phosphoric acid to form an anodic oxidation film having a plurality of pores on a surface of the substrate;
(ii) washing the substrate with water and then drying it with hot air; and
(iii) immersing the substrate in a pigment composition for coloration comprising pigment particles, a dispersing agent and water to fill the pigment particles into a plurality of the pores in the anodic oxidation film on the surface of the substrate, thereby performing coloration.

5. The method of claim 4, wherein the pore in the anodic oxidation film has a pore size between 20 and 200 nm and a death between 1 and 50 μm in a thickness direction.

6. The method of claim 4, wherein the hot air has a temperature between 50 and 150° C.

7. A method for manufacturing a colored aluminum product or a colored aluminum alloy product, comprising the following steps of:
(i) subjecting a substrate made of aluminum or aluminum alloy to an anodic oxidation in a treatment solution containing phosphoric acid to form an anodic oxidation film having a plurality of pores on a surface of the substrate;
(ii) treating the substrate with an alkaline aqueous solution having a pH between 9.0 and 10.0, and then washing it with water; and
(iii) immersing the substrate in a pigment composition for coloration comprising pigment particles, a dispersing agent and water to fill the pigment particles into a plurality of the pores in the anodic oxidation film on the surface of the substrate, thereby performing coloration.

8. The method of claim 7, wherein the pore in the anodic oxidation film has a pore size between 20 and 200 nm and a depth between 1 and 50 μm in a thickness direction from the surface.

9. The method of claim 7, wherein the alkaline aqueous solution is an aqueous ammonia hydroxide solution or an aqueous tetramethylammonium hydroxide solution.

10. A pigment composition for coloration which is used in the method for manufacturing the colored aluminum product or colored aluminum alloy product of claim 1, 4 or 7, comprising pigment particles, a dispersing agent and water, and having an oxidation-reduction potential of 200 mV or less,
Wherein the pigment particles have a particle size distribution in which a particle size of D 80 is less than a pore size of the minimum pore of a plurality of pores in an anodic oxidation film in a state in which the pigment particles are dispersed in the water containing the dispersing agent.

11. The pigment composition of claim 10, wherein the pigment particles have a particle size in which a particle size of D 80 or more is corresponded to 80% or less of a pore size of the minimum pore in the pores of the anodic oxidation film in a state in which the pigment particles are dispersed in the water containing the dispersing agent.

12. The pigment composition of claim 10, wherein the dispersing agent is an acrylic resin.

13. A colored aluminum product or colored aluminum alloy product comprising:
a substrate made of aluminum or aluminum alloy;
an anodic oxidation film formed on a surface of the substrate and comprising a plurality of pores with a pore size between 20 and 200 nm and a depth between 1 and 50 μm in a thickness direction from the surface; and
black pigment particles having a particle size less than the pore size of the pore and filling into a plurality of the pores in the anodic oxidation film so that a color difference, compared with the substrate before coloration as a standard, is 44 or more.

14. The colored aluminum product or colored aluminum alloy product of claim 13, wherein the black pigment particle has a particle size corresponding to 80% or less than the pore size of the pore in the anodic oxidation film.

15. The colored aluminum product or colored aluminum alloy product of claim 13, wherein the number of pores per the area of 25 μm² in the surface of the anodic oxidation film is between 1000 and 2200.

16. A colored aluminum product or colored aluminum alloy product comprising:
a substrate made of aluminum or aluminum alloy;
an anodic oxidation film formed on a surface of the substrate and having a plurality of pores with a pore size between 20 and 200 nm and a depth between 1 and 50 μm in a thickness direction from the surface; and
red pigment particles having a particle size less than the pore size of the pore and filling into a plurality of the pores in the anodic oxidation film so that a color difference, compared with the substrate before coloration as a standard, is 40 or more.

17. The colored aluminum product or colored aluminum alloy product of claim 16, wherein the red pigment particle has a particle size corresponding to 80% or less than a pore size of the pore in the anodic oxidation film.

18. The colored aluminum product or colored aluminum alloy product of claim 16, wherein the number of pores per the area of 25 μm² in the surface of the anodic oxidation film is between 1000 and 2200.

19. A colored aluminum product or colored aluminum alloy product comprising:
a substrate made of aluminum or aluminum alloy;
an anodic oxidation film, formed on a surface of the substrate, having a plurality of pores with a pore size between 20 and 200 nm and a depth between 1 and 50 μm in a thickness direction from the surface; and
blue pigment particles having a particle size less than the pore size of the pore and filling into a plurality of the pores in the anodic oxidation film so that a color difference, compared with the substrate before coloration as a standard, is 50 or more.

20. The colored aluminum product or colored aluminum alloy product of claim 19, wherein the blue pigment particle has a particle size corresponding to 80% or less than a pore size of the pore in the anodic oxidation film.

21. The colored aluminum product or colored aluminum alloy product of claim 19, wherein the number of pores per the area of 25 μm² in the surface of the anodic oxidation film is between 1000 and 2200.

22. A colored aluminum product or colored aluminum alloy product comprising:
a substrate made of aluminum or aluminum alloy;
an anodic oxidation film, formed on a surface of the substrate, having a plurality of pores with a pore size between 20 and 200 nm and a depth between 1 and 50 μm in a thickness direction from the surface; and
yellow pigment particles having a particle size less than the pore size of the pore and filling into a plurality of the pores in the anodic oxidation film so that a color difference, compared with the substrate before coloration as a standard, is 30 or more.

23. The colored aluminum product or colored aluminum alloy product of claim 22, wherein the yellow pigment particle has a particle size corresponding to 80% or less than a pore size of the pore in the anodic oxidation film.

24. The colored aluminum product or colored aluminum alloy product of claim 22, wherein the number of pores per the area of 25 μm² in the surface of the anodic oxidation film is between 1000 and 2200.

25. A colored aluminum product or colored aluminum alloy product comprising:
a substrate made of aluminum or aluminum alloy;
an anodic oxidation film formed on a surface of the substrate and having a plurality of pores with a pore size between 20 and 200 nm and a depth between 1 and 50 μm in a thickness direction from the surface; and
green pigment particles having a particle size less than the pore size of the pore and filling into a plurality of the pores in the anodic oxidation film so that a color difference, compared with the substrate before coloration as a standard, is 45 or more.

26. The colored aluminum product or colored aluminum alloy product of claim 25, wherein the green pigment particle has a particle size corresponding to 80% or less than a pore size of the pore in the anodic oxidation film.

27. The colored aluminum product or colored aluminum alloy product of claim 25, wherein the number of pores per the area of 25 μm² in the surface of the anodic oxidation film is between 1000 and 2200.

28. A colored aluminum product or colored aluminum alloy product comprising:
a substrate made of aluminum or aluminum alloy;
an anodic oxidation film formed on a surface of the substrate and having a plurality of pores with a pore size between 20 and 200 nm and a depth between 1 and 50 μm in a thickness direction from the surface; and
white pigment particles having a particle size less than the pore size of the pore and filling into a plurality of the pores in the anodic oxidation film so that a color difference, compared with the substrate before coloration as a standard, is 3.5 or more.

29. The colored aluminum product or colored aluminum alloy product of claim 28, wherein the white pigment particle has a particle size corresponding to 80% or less than a pore size of the pore in the anodic oxidation film.

30. The colored aluminum product or colored aluminum alloy product of claim 28, wherein the number of pores per the area of 25 μm² in the surface of the anodic oxidation film is between 1000 and 2200.
